(19) United States
(12) Patent Application Publication
(10) Pub. No.: US 2014/0060053 A1
(43) Pub. Date: Mar. 6, 2014

(54) STEAM POWER PLANT AND METHOD OF OPERATING A STEAM POWER PLANT

(71) Applicant: THORSTEN WOLF, Orlando, FL (US)

(72) Inventor: THORSTEN WOLF, Orlando, FL (US)

(21) Appl. No.: 13/596,703

(22) Filed: Aug. 28, 2012

(51) Int. Cl. F01K 13/00; F03G 6/06; F01K 9/00; F01K 7/22

(52) U.S. Cl. 60/676; 60/679; 60/641.15; 60/690; 60/645; 60/653

(57) ABSTRACT

A steam power plant with a steam turbine with a high pressure stage and a low pressure stage is provided. A first steam source provides a motive steam, and a second steam source provides a heating steam, wherein the motive steam and the heating steam have different qualities. A reheater is arranged between the high pressure stage and the low pressure stage. The motive steam is supplied to the high pressure stage and is reheated by the reheater after leaving the high pressure stage, wherein the reheater is operated with the heating steam. Further, a method of operating a steam power plant is provided.

### FIELD OF INVENTION

A steam power plant and a method of operating a steam power plant are provided.

### BACKGROUND OF INVENTION

In industrial and solar steam power plants water is heated, for example in a boiler, and turned into pressurized steam, wherein the steam, called motive steam or main steam or fresh steam, is used to drive a steam turbine which drives an electrical generator. After the steam passes through the turbine, the steam is condensed in a condenser. The steam turbine extracts thermal energy from the pressurized steam, wherein the steam is used to do mechanical work on a rotating output shaft. To maximize turbine efficiency, the steam is expanded in a plurality of stages, for example higher pressure stages and lower pressure stages.

The efficiency of steam power plants is determined mainly by the pressure and temperature of the steam flowing into the turbine stages and by the number of intermediate superheating stages and their respective superheating temperature.

Steam power plants use different types and cycles, for example reheat cycle and non-reheat cycle. In a reheat cycle, steam is expanded in a high pressure stage down to near-saturation and is then returned to the boiler for reheat to the original temperature but at a lower pressure. The steam then expands in the low pressure stage until it becomes as wet as the final blades of the steam turbine can tolerate. In a non-reheat cycle, steam is expanded through the turbine to exhaust from the condenser without returning to the boiler.

Industrial and solar steam plants use non-reheat cycle partly for the reason that the size of the heat source and the distance between a heat source, for example the (solar) reheater, and turbine is substantial, so that a classical steam re-heater would have large piping pressure losses diminishing its efficiency gains.

### SUMMARY OF INVENTION

An improved steam power plant, in particular an improved reheat cycle steam power plant is provided. Further, a method of operating the improved steam power plant is provided.

The steam power plant comprises a steam turbine with a high pressure stage and a low pressure stage, a first steam source providing a first quality steam, a second steam source providing a second quality steam, and a reheater arranged between the high pressure stage and the low pressure stage. The first quality steam is supplied to the high pressure stage and is reheated by the reheater after leaving the high pressure stage, wherein the reheater is operated with the second quality steam. The first quality steam is different from the second quality steam.

The first quality steam is superheated steam (also referred to as motive steam) and the second quality steam is saturated steam (also referred to as heating steam), wherein the second steam source supplies saturated steam to the reheater and the first steam source supplies superheated steam to the high pressure stage of the steam turbine.

In an embodiment, the first steam source and the second steam source comprise a common drum boiler operated with fossil fuel, wherein the saturated steam (second quality steam) is taken out of the drum of the drum boiler, wherein the superheated steam (first quality steam) is taken out of the superheating section of the drum boiler.

In another embodiment, the heating steam is produced in a different steam generator which is separate from the steam generator for the motive steam. The efficiency effect is even higher when the second steam source producing the heating steam produces steam with higher pressure than the motive steam generator.

In an embodiment, the first steam source which provides the first quality steam and the second steam source which provides the second quality steam each comprise a drum boiler operated with fossil fuel.

In another embodiment, the first steam source providing the superheated steam comprises a concentrated solar power (CSP) system, for example a Linear Fresnel (LF) solar field or a solar power tower with a central receiver.

In another embodiment, the second steam source providing the saturated steam comprises a concentrated solar power (CSP) system, for example a Linear Fresnel (LF) solar field or a solar power tower with a central receiver.

CSP systems use mirrors or lenses to concentrate a large area of sunlight, or solar thermal energy, onto a small area. LF (direct steam) technology means that sun radiation is focused in an array of long, flat or slightly curved tracking mirrors on a linear receiver pipe positioned above the array. A solar power tower with a central receiver comprises a circular array of flat heliostats (sun tracking mirrors) concentrating sunlight on to a central receiver at the top of the tower. Water, the heat transfer medium, in the receiver absorbs the thermal energy.

In a further embodiment, the steam power plant comprises a second reheater connected to the second steam source operating the second reheater with saturated steam, wherein the second reheater may be connected to the low pressure stage of the steam turbine.

Furthermore, the steam power plant comprises a condenser connected downstream of the low pressure stage of the steam turbine and a plurality of regenerative pre-heaters connected downstream of the high and low pressure stages of the steam turbine. Condensate leaving the condenser is supplied to the pre-heaters, wherein the pre-heaters preheat the condensate, and supply the preheated condensate to the first steam source.

A method of operating such a steam power plant comprises the steps of arranging a reheater between a high pressure stage and a low pressure stage of a steam turbine, supplying first quality steam to the high pressure stage, and reheating the first quality steam after leaving the high pressure stage by the reheater, wherein the reheater is operated with second quality steam.

The first quality steam is superheated steam and the second quality steam is saturated steam, wherein the second steam source supplies saturated steam to the reheater and the first steam source supplies superheated steam to the high pressure stage of the steam turbine. The reheater produces the saturated steam with a higher pressure than the superheated steam.

The improved steam power plant and the provided method use the effect that heating steam, which is at saturation (second quality steam), or only slightly superheated, has a minimum exergy content of steam. The exergy describes the maximum useful work possible during a process, i.e. it is the capability to do mechanical work. As the exergy is minimal or very low, the heating steam has no capability to do mechanical work and is acting as heat transfer fluid only. Therefore, the condensate of the heating steam is directly pumped back to the second steam source, which is a heating steam generator, for example a drum boiler.

The provided steam power plant uses heating steam from a second steam source, which is a different heating source compared to the first steam source, to reheat the first quality steam in a reheater close to the steam turbine, thus providing an increase of efficiency of reheating without the efficiency-reducing effect of piping pressure loss.

Known systems, which include a reheater close to the turbine and use steam as heating medium (for example a Moisture Separator Reheater in nuclear plants), use a part of the motive steam (first quality steam) as heating steam for reheating the steam in between pressure stages. In such a case, the exergy content of the heating steam is equal to the exergy content of the motive steam. The exergy of the motive steam is lost in the condensing process in the reheater, since no mechanical work is done with the heating steam.

### BRIEF DESCRIPTION OF THE DRAWINGS

FIG. 1 shows a first embodiment of a steam power plant.

FIG. 2 shows a second embodiment of a steam power plant.

FIG. 3 shows a third embodiment of a steam power plant.

### DETAILED DESCRIPTION OF INVENTION

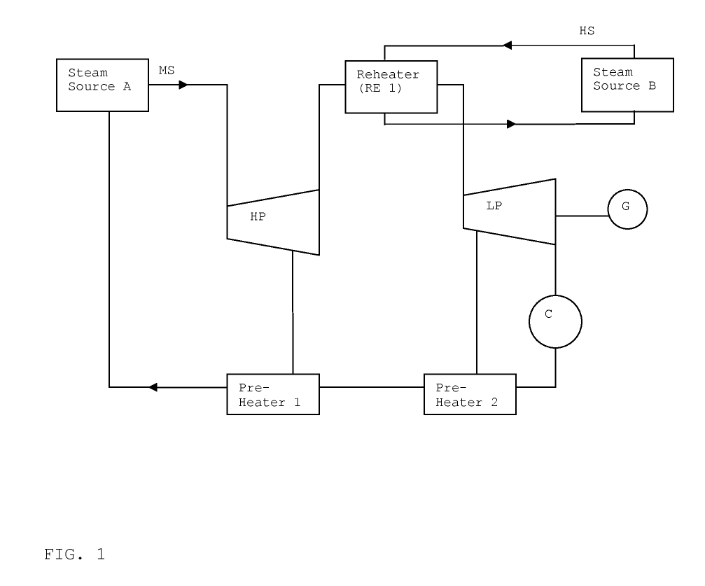

FIG. 1 shows a steam turbine comprising a high pressure stage HP and a low pressure stage LP. The steam turbine may also comprise a medium pressure stage (not shown in FIG. 1). For the generation of electrical energy, the steam turbine is coupled to a generator G which may be located on the same shaft as the turbine stages HP and LP.

To operate the steam turbine, motive steam MS, also called main steam or fresh steam, generated by the steam source A, is supplied to the high pressure stage HP. The source A may be a steam boiler, for example a drum boiler operated with fossil fuel, or a solar powered heating source, for example a Linear Fresnel (LF) solar field, or a solar power tower with a central receiver.

The motive steam MS leaves the high pressure section HP, after work has been performed in the high pressure stage HP, and is reheated by a reheater RE 1, for example a surface heat exchanger, and is supplied to the low pressure section LP and is expands in a condenser C, wherein the condensate is pumped through a regenerative preheating system including Pre-Heater 1 and Pre-Heater 2 back to the heating source A.

The steam source B, which is used for the reheater RE 1, provides saturated heating steam HS. The source B produces the saturated steam with a higher pressure than the superheated steam. The saturated heating steam HS is condensed in the reheater RE 1 to supply the energy for reheating the motive steam MS. The resulting condensate is then pumped back to the source B.

In FIG. 1, the steam source B is arranged close to the steam turbine, and steam source A and steam source B are separate sources. Steam source B may be a steam boiler, for example a drum boiler operated with fossil fuel, or a solar powered heating source, for example a Linear Fresnel (LF) solar field, or a solar power tower with a central receiver.

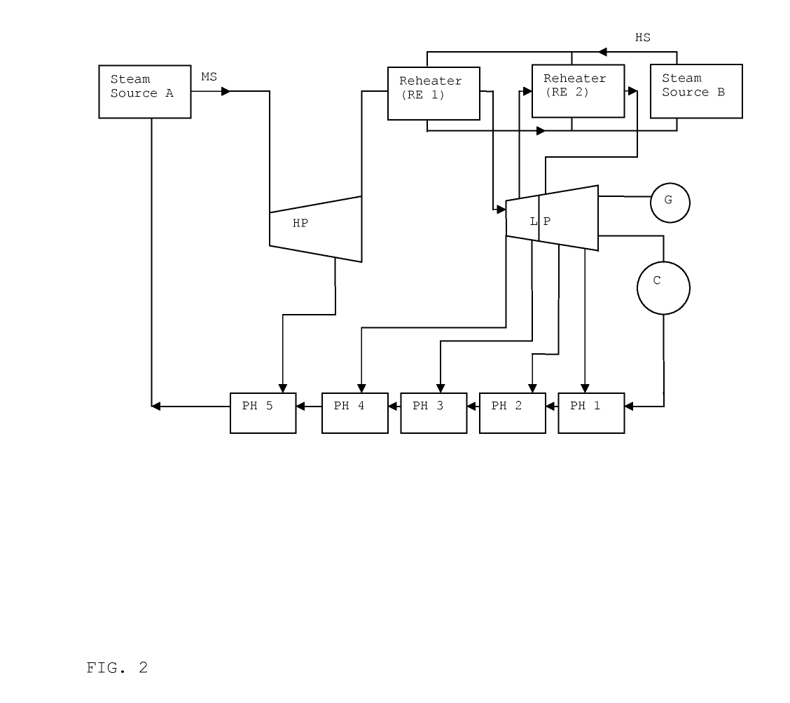

FIG. 2 shows a second embodiment, wherein the steam turbine comprises a plurality of low pressure sections LP. In this case, the steam power plant includes another reheater RE 2 for reheating the motive steam in between different low pressure sections LP of the steam turbine. The steam power plant may comprise a plurality of reheaters which are close to the steam turbine for reheating the motive steam.

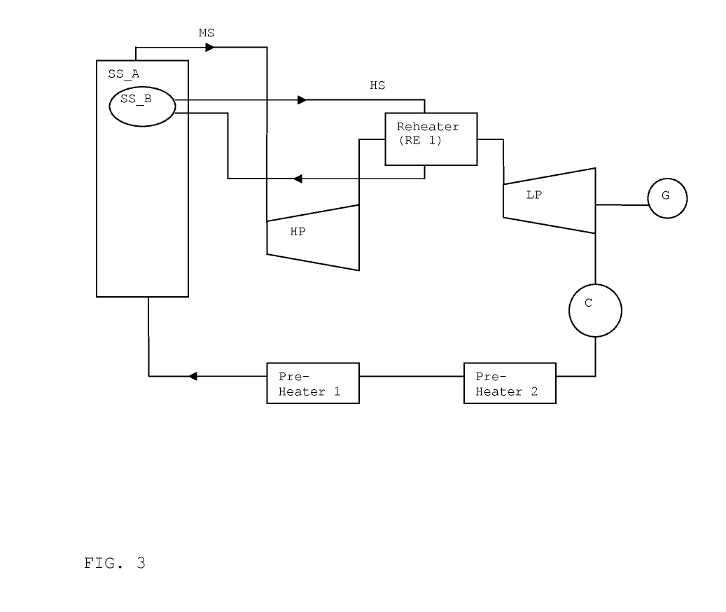

FIG. 3 shows a third embodiment, wherein the steam source A (SS_A) and the steam source B (SS_B) are included in a common source. For example, the common source is a drum boiler operated with fossil fuel, wherein the saturated steam (heating steam) is taken out of the drum of the drum boiler, wherein the superheated steam (motive steam) is taken out of the superheating section of the drum boiler.

Further benefits and characteristics of the provided steam power plant are:
The reheating of the steam in a steam cycle does not only result in higher efficiency but also reduces wetness of steam in the low pressure section of the turbine.
The solution may be retrofitted to existing plants (steam plants and combined cycle) by using the saturated steam directly from the drum of the steam generator and adding a reheater in the crossover pipe between IP and LP.
The reheating of the motive steam with saturated steam may be done several times, e.g. as Double-Reheat.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. Steam power plant, comprising:
a steam turbine with a high pressure stage and a low pressure stage,
a first steam source providing motive steam,
a second steam source providing heating steam,
a reheater arranged between the high pressure stage and the low pressure stage,
wherein the motive steam is supplied to the high pressure stage and is reheated by the reheater after leaving the high pressure stage,
wherein the reheater is operated with the heating steam, and
wherein the motive steam and the heating steam have different qualities.

2. The steam power plant as claimed in claim 1, wherein the motive steam is superheated steam and the heating steam is saturated steam, wherein the second steam source supplies saturated steam to the reheater and the first steam source supplies superheated steam to the high pressure stage of the steam turbine.

3. The steam power plant as claimed in claim 1, wherein the second steam source-reheater produces the saturated steam with a higher pressure than the superheated steam.

4. The steam power plant as claimed in claim 1, wherein the first steam source comprises a drum boiler operated with fossil fuel, or a Linear Fresnel (LF) solar field, or a solar power tower with a central receiver.

5. The steam power plant as claimed in claim 1, wherein the second steam source comprises a drum boiler operated with fossil fuel, or a Linear Fresnel (LF) solar field, or a solar power tower with a central receiver.

6. The steam power plant as claimed in claim 2, wherein the first steam source and the second steam source comprise a common drum boiler operated with fossil fuel, wherein the drum of the drum boiler supplies the saturated steam, and the superheating section of the drum boiler supplies the superheated steam.

7. The steam power plant as claimed in claim 1, further comprising:
a second reheater connected to the second steam source, wherein the second steam source supplies saturated steam to the second reheater.

8. The steam power plant as claimed in claim 1, further comprising:
a condenser connected downstream of the low pressure stage of the steam turbine;
a plurality of regenerative pre-heaters connected downstream of the high and low pressure stages of the steam turbine,
wherein condensate leaving the condenser is supplied to the pre-heaters,
wherein the pre-heaters preheat the condensate, and
wherein the preheated condensate is supplied to the first steam source.

9. Method of operating a steam power plant, comprising:
arranging a reheater between a high pressure stage and a low pressure stage of a steam turbine,
supplying motive steam to the high pressure stage,
reheating the motive steam after leaving the high pressure stage by the reheater, wherein the reheater is operated with heating steam,
wherein the motive steam and the heating steam have different qualities.

10. The method as claimed in claim 9, wherein the motive steam is superheated steam and the heating steam is saturated steam, wherein a second steam source supplies saturated steam to the reheater and a first steam source supplies superheated steam to the high pressure stage of the steam turbine.

11. The method as claimed in claim 9, wherein the reheater produces the saturated steam with a higher pressure than the superheated steam.

12. The method as claimed in claim 10, wherein the first steam source and the second steam source comprise a common drum boiler operated with fossil fuel, wherein the saturated steam is provided by the drum of the drum boiler, and wherein the superheated steam is provided by the superheating section of the drum boiler.

13. The method as claimed in claim 10, further comprising:
arranging a second reheater between a plurality of low pressure stages of the steam turbine,
connecting the second reheater to the second steam source, and
operating the second reheater with saturated steam

14. The method as claimed in claim 10, further comprising:
connecting a condenser downstream of the low pressure stage of the steam turbine;
connecting a plurality of regenerative pre-heaters downstream of the high and low pressure stages of the steam turbine,
supplying condensate leaving the condenser to the pre-heaters,
preheating the condensate by the pre-heaters preheat the condensate, and
supplying the preheated condensate to the first steam source.
